(19) United States
(12) Patent Application Publication
(10) Pub. No.: US 2023/0383737 A1
(43) Pub. Date: Nov. 30, 2023

(54) SUCKING AND AIR BLOWING STRUCTURE AND MASSAGING DEVICE

(71) Applicant: Huang Zhong Dong, Shenzhen (CN)

(72) Inventor: Huang Zhong Dong, Shenzhen (CN)

(21) Appl. No.: 17/864,703

(22) Filed: Jul. 14, 2022

(30) Foreign Application Priority Data
May 30, 2022 (CN) 202210734371.7

(51) Int. Cl. F04B 35/04; F04B 9/02; A61H 9/00

(52) U.S. Cl. CPC F04B 35/04; F04B 9/02; A61H 9/0057; A61H 2201/1246; A61H 2201/0107

(57) ABSTRACT

The present disclosure provides a sucking and air blowing structure, and a massaging device. The sucking and air blowing structure includes a driving device, provided with a piston, the piston is capable of linearly reciprocating under an action of the driving device; and a venting device, connected with the driving device, the venting device defines a cavity cooperated with the piston, the piston is capable of linearly reciprocating in the cavity, the venting device further defines a first air outlet communicated with the cavity; when the piston linearly reciprocates in the cavity, internal air pressure and external air pressure of the cavity are balanced through the first air outlet, to form a sucking and air blowing effect. Under the action of the driving device, the piston reciprocates in the cavity to suck and blow air to the body, so as to quickly stimulate the skin.

The present disclosure relates to the technical field of massaging devices, and in particular to sucking and air blowing structures and massaging devices having the sucking and air blowing structure. This application claims priority to Chinese Application No. 202210734371.7 filed on May 30, 2022.

### BACKGROUND OF THE INVENTION

After working daily, a person may be tired. People may use massaging devices to relieve fatigue. There are many kinds of massaging devices on the market, the existing massaging devices may be divided into manual massaging devices and electric massaging devices according to the way of use, and may also be divided into soothing type massaging devices and stimulating type massaging devices.

Most of the stimulating massaging devices are electric. The existing massaging devices are used to pump, knock, scratch, or grasp the body, to stimulate the body. As the motors of the existing massaging devices rotate radially to provide power, the existing massaging devices cannot suck the body or blow air to the body.

What is needed is a sucking and air blowing structure and a massaging device where the massaging device has the sucking and air blowing functions.

### SUMMARY OF THE INVENTION

In order to achieve the above objective, the present disclosure provides a sucking and air blowing structure, applied to a massaging device. The sucking and air blowing structure includes: a driving device, provided with a piston, the piston is capable of linearly reciprocating under an action of the driving device; and a venting device, connected with the driving device, the venting device defines a cavity cooperated with the piston, the piston is capable of linearly reciprocating in the cavity, the venting device further defines a first air outlet communicated with the cavity; when the piston linearly reciprocates in the cavity, internal air pressure and external air pressure of the cavity are balanced through the first air outlet, to form a sucking and air blowing effect.

In some embodiments, the sucking and air blowing structure further includes a boosting device, arranged at the first air outlet and sealingly connected with a side wall of the first air outlet, the boosting device defines a second air outlet, a diameter of the second air outlet is larger than a diameter of the first air outlet.

In some embodiments, the boosting device is a straight air outlet pipe integrally formed with the side wall of the first air outlet.

In some embodiments, the straight air outlet pipe includes a flexible air outlet pipe, the flexible air outlet pipe is bendable, a free end of the flexible air outlet pipe is connected with a first air outlet head, the first air outlet head is matched with a sensitive portion of a user in shape, and configured to inhale air and blow out air.

In some embodiments, the boosting device is a second air outlet head sealingly connected with the the side wall of first air outlet, and the second air outlet head is matched with a sensitive portion of a user in shape, and configured to inhale air and blow out air.

In some embodiments, the sucking and air blowing structure further includes a sealing ring arranged on a side wall of the piston, and the sealing ring is sealingly connected with an inner side wall of the cavity.

In some embodiments, the driving device is a linear motor or a voice coil motor.

In some embodiments, the driving device includes: a driving motor; a first connecting rod, an end of the first connecting rod is connected with an output shaft of the driving motor; a second connecting rod, an end of the second connecting rod is connected with an end of the first connecting rod away from the output shaft of the driving motor; and a moving shaft, an end of the moving shaft is connected with the piston, and other end of the moving shaft is connected with an end of the second connecting rod away from the first connecting rod; when the output shaft of the driving motor rotates, the output shaft is configured to drive the first connecting rod to rotate, and drive the moving shaft to reciprocate linearly through the second connecting rod.

In some embodiments, the driving device includes: a double shaft driving motor; a third connecting rod; a fourth connecting rod, the third connecting rod and the fourth connecting rod are respectively connected with both ends of the double shaft driving motor; a fifth connecting rod, two ends of the fifth connecting rod are respectively connected with the third connecting rod and the fourth connecting rod; and a moving shaft, one end of the moving shaft is connected with the piston, and other end of the moving shaft is connected with the fifth connecting rod; when an output shaft of the double shaft driving motor rotates, the output shaft is configured to drive the third connecting rod and the fourth connecting rod to rotate, and drive the moving shaft to reciprocate linearly through the fifth connecting rod.

The present disclosure further provides a massaging device, which includes an upper housing, a lower housing detachably connected with the upper housing, and a sucking and air blowing structure, the upper housing and the lower housing cooperatively form a receiving space for receiving the sucking and air blowing structure, the sucking and air blowing structure includes: a driving device, provided with a piston, the piston is capable of linearly reciprocating under an action of the driving device; and a venting device, connected with the driving device, the venting device defines a cavity cooperated with the piston, the piston is capable of linearly reciprocating in the cavity, the venting device further defines a first air outlet communicated with the cavity; when the piston linearly reciprocates in the cavity, internal air pressure and external air pressure of the cavity are balanced through the first air outlet, to form a sucking and air blowing effect.

In some embodiments, the massaging device further includes a battery and a printed circuit board both received in the receiving space, the printed circuit board is electrically connected with the battery, and the battery is configured to provide a power to the driving device.

In some embodiments, the massaging device further includes a waterproof ring, the waterproof ring includes a body, the body defines a via hole, the driving device includes a moving shaft, the moving shaft is configured to pass through the via hole and connect with the piston.

In some embodiments, a diameter of the via hole is smaller than a diameter of the moving shaft, so that a side wall of the via hole is sealingly connected to the moving shaft; or the body of the waterproof ring comprises a plurality of annular grooves arranged at intervals, and the annular grooves are arranged concentrically; or the waterproof ring is elastic.

In some embodiments, the sucking and air blowing structure includes a boosting device, arranged at the first air outlet and sealingly connected with a side wall of the first air outlet, the boosting device defines a second air outlet, a diameter of the second air outlet is larger than a diameter of the first air outlet.

In some embodiments, the sucking and air blowing structure includes a sealing ring arranged on a side wall of the piston, and the sealing ring is sealingly connected with an inner side wall of the cavity; or the driving device is a linear motor or a voice coil motor.

The beneficial effects of the present disclosure include: compared with the existing massaging device, the massaging device of the present disclosure adopts a new sucking and air blowing structure. Driven by the driving device, the piston linearly reciprocates in the cavity, for sucking the sensitive portion of body and blowing air to the sensitive portion, to massage and stimulate the sensitive portion.

### BRIEF DESCRIPTION OF THE DRAWINGS

In order to more clearly illustrate the embodiments of the present disclosure or the technical solutions in the related art, the drawings to be used in the embodiments or description of the related art will be briefly described below. Obviously, the drawings in the following description are only certain embodiments of the present disclosure, and other drawings may be obtained according to the structures shown in the drawings without any creative work for a person having ordinary skill in the art.

FIG. 1 is a structural diagram of the driving device of the sucking and air blowing structure of the massaging device according to the first embodiment of the present disclosure.

FIG. 2 is a structural diagram of the driving device of the sucking and air blowing structure of the massaging device according to the second embodiment of the present disclosure.

FIG. 3 is similar to FIG. 2, but shown in another view.

FIG. 4 is a structural diagram of the driving device of the sucking and air blowing structure of the massaging device according to the third embodiment of the present disclosure.

FIG. 5 is similar to FIG. 4, but shown in another view.

FIG. 6 is a structural diagram of the sucking and air blowing structure of the massaging device according to the first embodiment of the present disclosure.

FIG. 7 is a cross-sectional diagram of the sucking and air blowing structure of FIG. 6.

FIG. 8 is a structural diagram of the sucking and air blowing structure of the massaging device according to the second embodiment of the present disclosure.

FIG. 9 is a cross-sectional diagram of the sucking and air blowing structure of FIG. 8.

FIG. 10 is a structural diagram of the sucking and air blowing structure of the massaging device according to the third embodiment of the present disclosure.

FIG. 11 is a structural diagram of the sucking and air blowing structure of the massaging device according to the fourth embodiment of the present disclosure.

FIG. 12 is a structural diagram of the second air outlet head of the sucking and air blowing structure of the massaging device of the present disclosure.

FIG. 13 is similar to FIG. 12, but shown in another view.

FIG. 14 is a structural diagram of the first air outlet head of the sucking and air blowing structure of the massaging device of the present disclosure.

FIG. 15 is a structural diagram of the massaging device according to an embodiment of the present disclosure.

FIG. 16 is a structural diagram of the waterproof ring of the massaging device of FIG. 15.

The implementation, functional features and advantages of the present disclosure will be further described with reference to the accompanying drawings.

### DETAILED DESCRIPTION OF THE EMBODIMENTS

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present disclosure without creative efforts shall fall within the scope of the present disclosure.

It should be noted that, the descriptions, such as “first”, “second” in some embodiments of the present disclosure, can only be used for describing the aim, and cannot be understood as indicating or suggesting relative importance or impliedly indicating the number of the indicated technical feature. Therefore, the feature defined by the “first”, the “second” can express or impliedly include at least one feature.

Besides, the meaning of “and/or” appearing in the full text includes three paratactic schemes. Take “A and/or B” as an example, including the A scheme, or the B scheme, or the scheme in which both A and B are simultaneously satisfied.

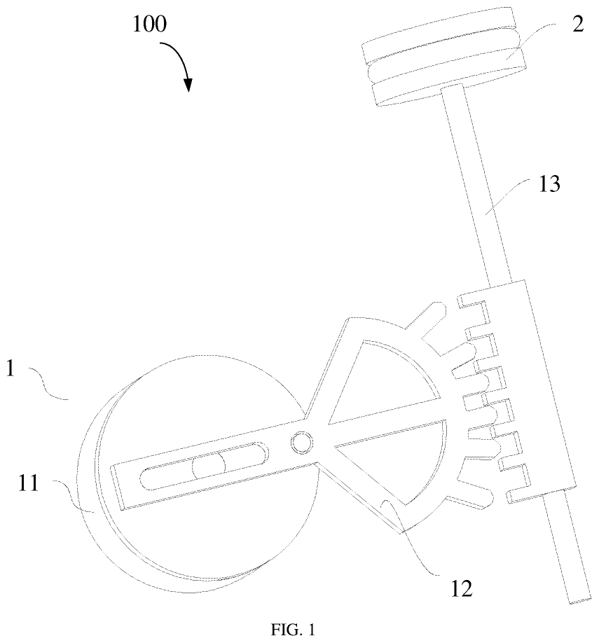

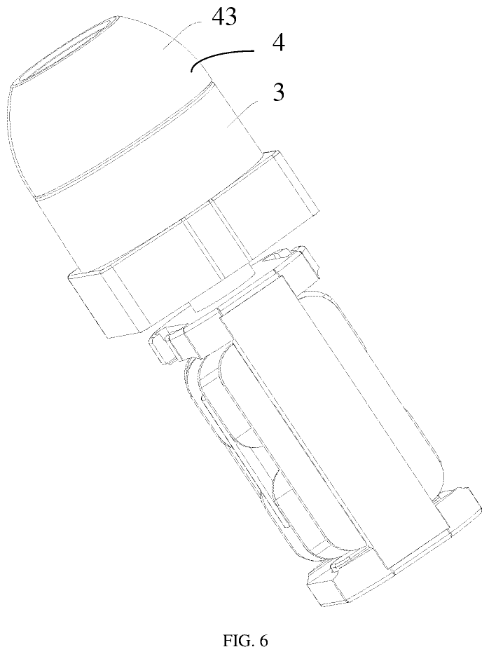

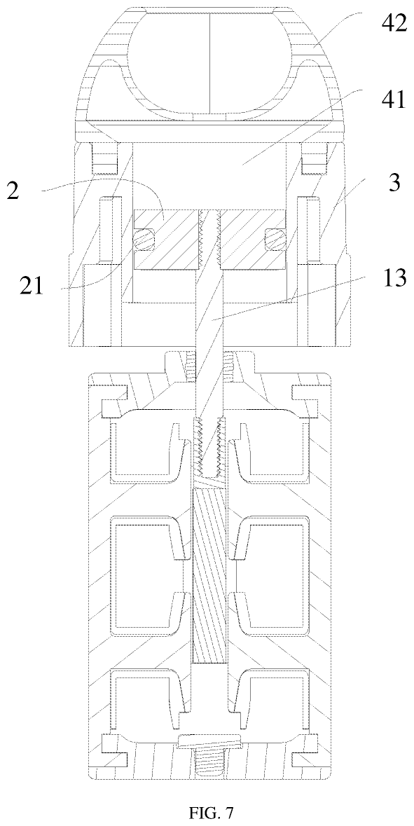

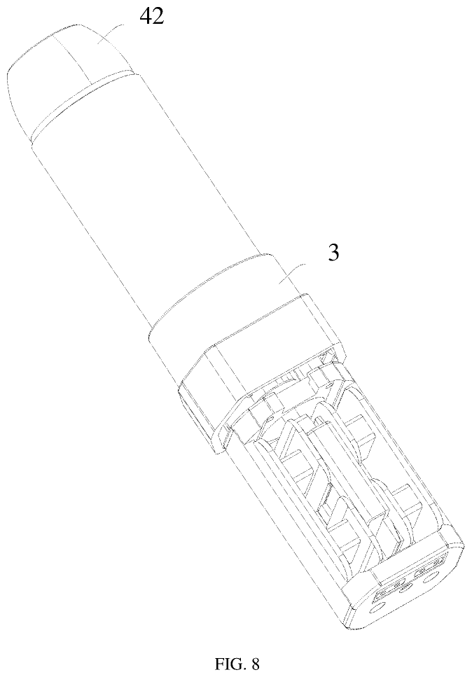

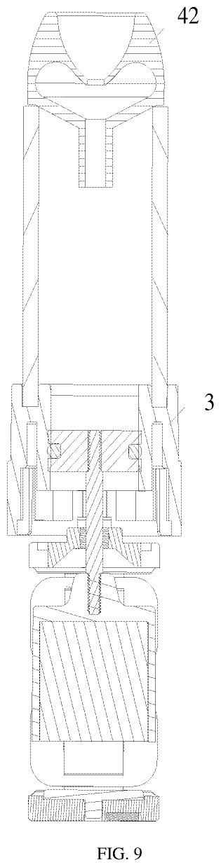

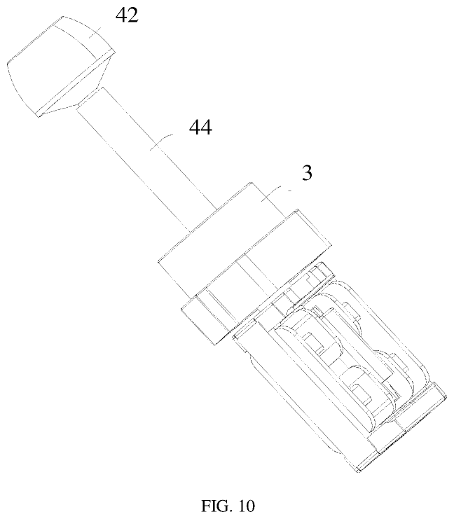

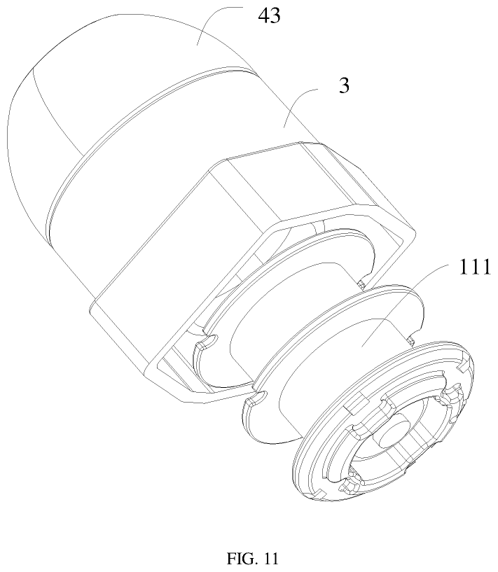

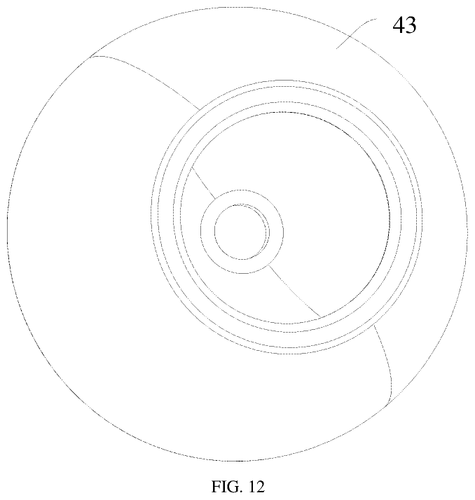

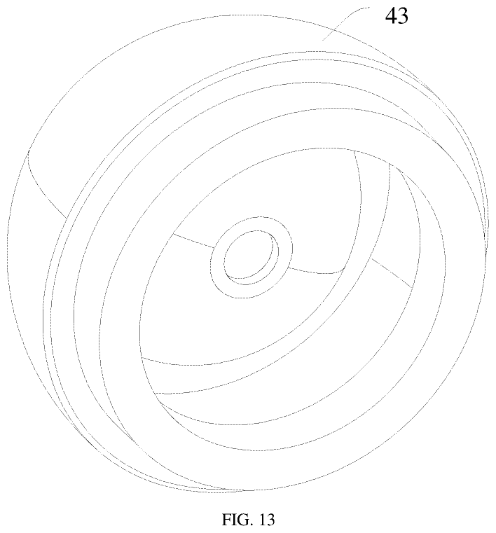

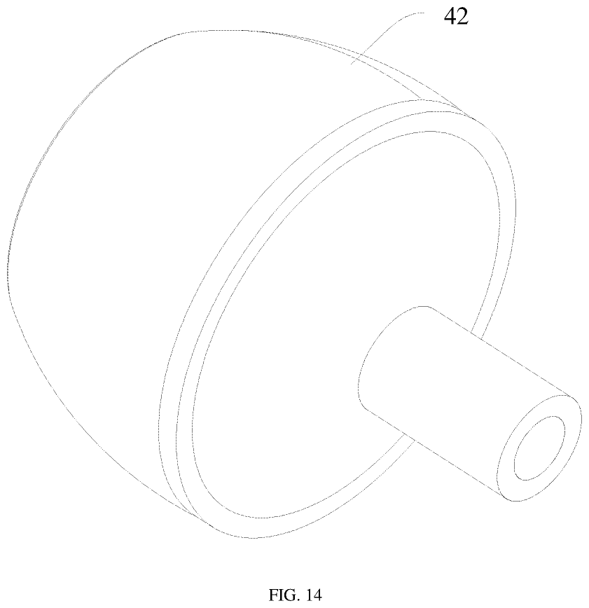

Referring to FIGS. 1 to 14, the present disclosure provides a sucking and air blowing structure 100, applied to a massaging device 200. The sucking and air blowing structure 100 includes: a driving device 1, provided with a piston 2, the piston 2 is capable of linearly reciprocating under an action of the driving device 1; a venting device 3, connected with the driving device 1, the venting device 3 has a cavity cooperating with the piston 2, the piston 2 is capable of linearly reciprocating in the cavity 31, the venting device 3 also defines a first air outlet 33 communicated with the cavity 31. When the piston 2 linearly reciprocates in the cavity 31, internal air pressure and external air pressure of the cavity 31 are balanced through the first air outlet 33, to form a sucking and air blowing effect.

Specifically, in the technical solution of the present disclosure, the driving device 1 is configured to drive the piston 2 to linearly reciprocate in the cavity 31, so that air may be blown out of the first air outlet 33 or sucked into the first air outlet 33 under the cooperation of the piston 2 and the cavity 31.

In some embodiments, the sucking and air blowing structure 100 further includes: a boosting device 4, arranged at the first air outlet 33 and sealingly connected with a side wall of the first air outlet 33, the boosting device 4 defines a second air outlet 41, a diameter of the second air outlet 41 is larger than a diameter of the first air outlet 33.

Specifically, in the technical solution of the present disclosure, the boosting device 4 is arranged at the first air outlet 33. By reducing a diameter of the second air outlet 41, the air outlet pressure is larger, which greatly improves the massage intensity and stimulates the human body better.

In some embodiments, the boosting device 4 is a straight air outlet pipe integrally formed with the side wall of the first air outlet 33.

In some embodiments, the straight air outlet pipe includes a flexible air outlet pipe 44, the flexible air outlet pipe 44 is bendable, a free end of the flexible air outlet pipe 44 is connected with a first air outlet head 42, the first air outlet head 42 is matched with the sensitive portion of the user in shape, and configured to inhale air and blow out air.

Specifically, the present disclosure adopts the flexible air outlet pipe 44. When the sucking and air blowing structure 100 is applied to different products, the first air outlet 33 can be arranged at suitable positions according to the actual needs of the product, and the flexible air outlet pipe 44 with suitable length is selected. In this way, the sucking and air blowing structure may be applied to different products.

In some embodiments, the boosting device 4 is a second air outlet head 43 sealingly connected with the side wall of the first air outlet 33, and the second air outlet head 43 is matched with the sensitive portion of the user in shape, and configured to inhale air and blow out air.

In some embodiments, a sealing ring 21 is arranged on a side wall of the piston 2, and the sealing ring 21 is sealingly connected with an inner side wall of the cavity 31.

Specifically, in the technical solution of the present disclosure, the sealing ring 21 is arranged on the side wall of the piston 2, so that the side wall of the piston 2 can be sealingly connected with the inner wall of the cavity 31. In this way, the sucking pressure and the air blowing pressure are greater, and the stimulating effect is improved.

In some embodiments, the driving device 1 is a linear motor.

Specifically, the structure of the linear motor can be referred to the Chinese invention (patent No. 201921801261.8). The linear motor includes a motor housing, a mover assembly and a stator assembly installed in the motor housing. The motor housing is fixed with a housing of the massaging device 200, and the mover assembly is located on an inner side of the stator assembly.

The mover assembly includes an output shaft, a coupling bracket and a plate-shaped permanent magnet, the coupling bracket is fixedly connected to the output shaft, and the plate-shaped permanent magnet is embedded in the coupling bracket.

The stator assembly includes one or more sets of stator cores fixed on the motor housing, a winding skeleton fastened to the stator core, and a winding coil wound on the winding skeleton, the stator cores are correspondingly distributed along two poles of the magnetic field of plate-shaped permanent magnet.

In the design scheme of the linear motor, the permanent magnet is used as a magnetic source, and the coupling bracket is arranged in the motor to fix the permanent magnet, and the stator cores corresponding to the permanent magnet are arranged on an outer side of the mover assembly. The stator cores arranged on the outer side of the mover assembly form a complete motor magnetic circuit, so that the linear motor has a simple structure and a low cost, and the air gap between the permanent magnet and the stator core can also be effectively shortened. While the magnetic circuit in the motor is formed, the magnetic circuit is tight and has less magnetic leakage. After the eddy current loss is reduced, an electromagnetic energy utilization rate, an effective power, and a working efficiency of the motor are all improved.

In some embodiments, the driving device 1 is a voice coil motor 111, the voice coil motor 111 can be referred to the Chinese invention (patent No. 2019218012618), the voice coil motor 11 includes a coil assembly and a magnetic element. One of the coil assembly and the magnetic element has a cavity extending through the coil assembly or the magnetic element in an axial direction, and the other one of the coil assembly and the magnetic element is movably arranged in the cavity. The coil assembly gradually generates a magnetic field which can act on the magnetic element when energized, so as to drive the magnetic element to reciprocate relative to the coil assembly, or drive the coil assembly itself to reciprocate axially relative to the magnetic element.

As shown in FIG. 1, in some embodiments, the driving device 1 includes: a forward and reverse motor 11; a fan-shaped driving tooth 12, one end of the fan-shaped driving teeth 12 is connected to an output shaft of the forward and reverse motor 11. Under the action of the forward and reverse motor 11, the fan-shaped driving teeth 12 rotates backward or forward, an arc edge of the fan-shaped driving tooth 12 has a plurality of engaging teeth; and a moving shaft 13, one end of the moving shaft 13 is connected with the piston 2, and the moving shaft 13 is provided with a plurality of engaging grooves matched with the engaging teeth; when the forward and reverse motor 11 rotates, the fan-shaped driving tooth 12 rotates backward or forward, thereby driving the moving shaft 13 to reciprocate linearly.

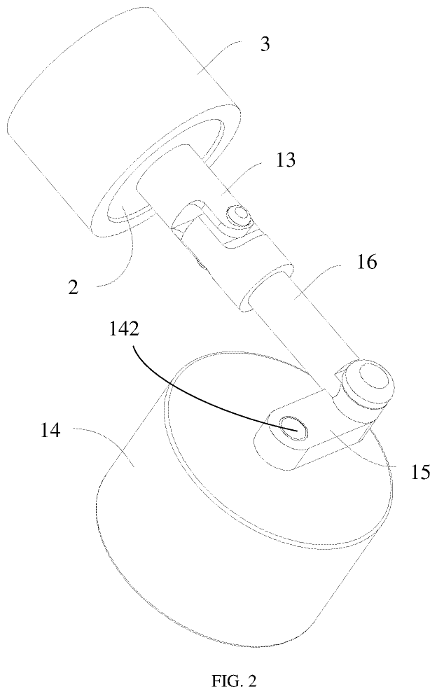

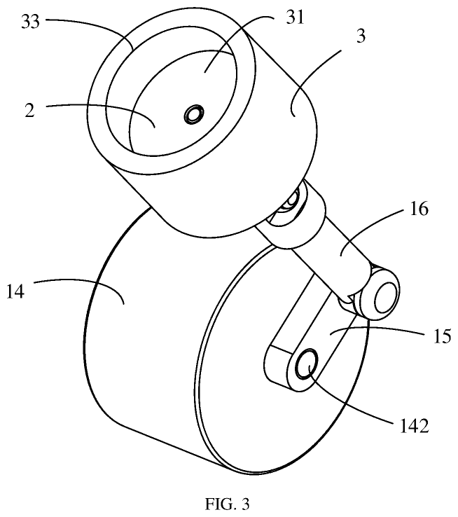

As shown in FIGS. 2-3, in some embodiments, the driving device 1 includes: a driving motor 14; a first connecting rod 15, one end of the first connecting rod 15 is connected with an output shaft 142 of the driving motor 14; a second connecting rod 16, one end of the second connecting rod 16 is connected with an end of the first connecting rod 15 away from the output shaft 142 of the driving motor 14; a moving shaft 13, one end of the moving shaft 13 is connected with the piston 2, and the other end of the moving shaft 13 is connected with an end of the second connecting rod 16 away from the first connecting rod 15; when the output shaft of the driving motor 14 rotates, the output shaft drives the first connecting rod 15 to rotate, and brings the moving shaft 13 to linearly reciprocate through the second connecting rod 16.

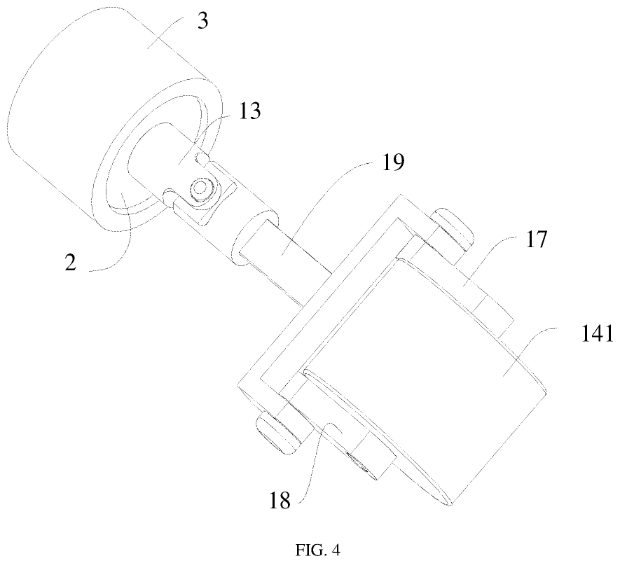

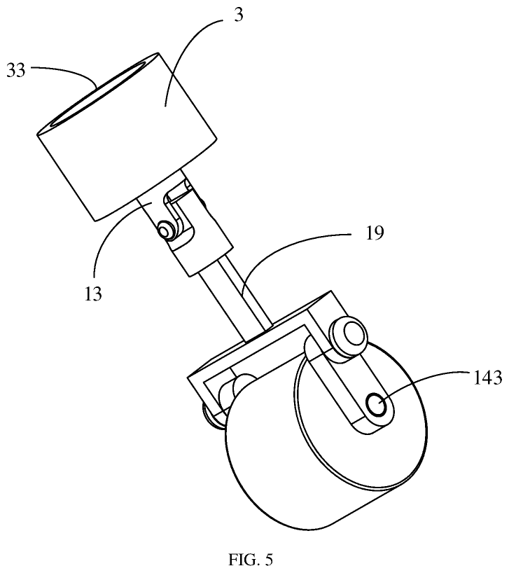

As shown in FIGS. 4-5, in some embodiments, the driving device 1 includes: a double shaft driving motor 141; a third connecting rod 17; a fourth connecting rod 18, the third connecting rod 17 and the fourth connecting rod 18 are respectively connected with both ends of the double shaft driving motor 141; a fifth connecting rod 19, two ends of the fifth connecting rod 19 are respectively connected with the third connecting rod 17 and the fourth connecting rod 18; and a moving shaft 13, one end of the moving shaft 13 is connected with the piston 2, and the other end of the moving shaft 13 is connected with the fifth connecting rod 19; when an output shaft 143 of the double shaft driving motor 141 rotates, the output shaft 143 drives the third connecting rod 17 and the fourth connecting rod 18 to rotate, and brings the moving shaft 13 to linearly reciprocate through the fifth connecting rod 19.

To sum up, the present disclosure changes the driving mode of the existing massaging device. Under the action of the driving device 1, the piston 2 reciprocates in the cavity to suck and blow air to the body, so as to quickly stimulate the skin.

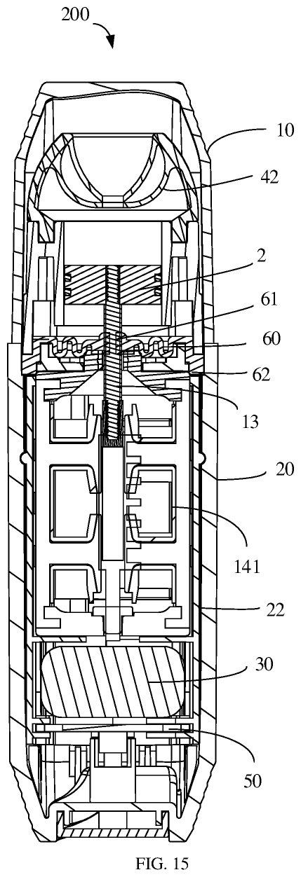

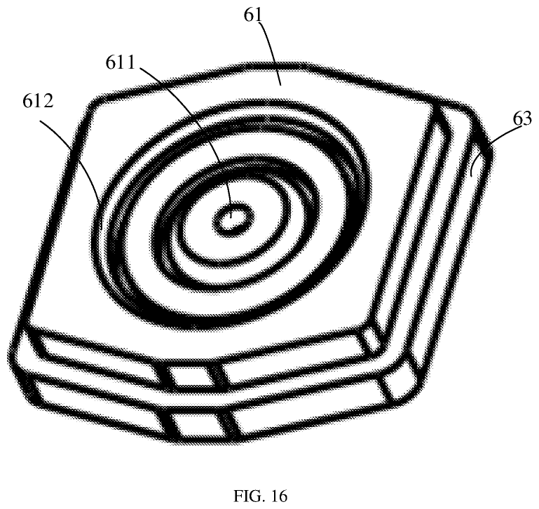

Referring to FIGS. 15 and 16, the present disclosure further includes a massaging device 200. The massaging device 200 includes the sucking and air blowing structure 100.

In at least one embodiment, the massaging device 200 includes an upper housing 10, and a lower housing 20 detachably connected with the upper housing 10, the upper housing 10 and the lower housing 20 cooperatively form a receiving space.

In at least one embodiment, the upper housing 10 may be separated from the lower housing 20 to expose the first air outlet 33 and the second air outlet 41.

In at least one embodiment, the massaging device 200 may have a lipstick shape, a rosette shape, or a square shape. It should be understood that the shape of the massaging device 100 can be designed according to actual requirements.

In at least one embodiment, the massaging device 200 includes a battery 30 and a printed circuit board (PCB) 50 both received in the receiving space, the printed circuit board 50 is electrically connected with the battery 30, and the battery 30 is configured to provide a power to the driving device 1.

In at least one embodiment, the massaging device 200 includes a waterproof ring 60, the waterproof ring 60 includes a body 61, the body 61 defines a via hole 611, the moving shaft 13 of the driving device 1 is configured to pass through the via hole 611 and connect with the piston 2.

Preferably, when the moving shaft 13 passes through the via hole 611, the side wall of the via hole 611 tightly wraps the moving shaft 13, so that the side wall of the through hole 611 can be sealingly connected with the moving shaft 13 to prevent water from entering into the driving device 1 through the via hole 611.

In at least one embodiment, a diameter of the via hole 611 is smaller than a diameter of the moving shaft 13, so that the side wall of the via hole 611 is sealingly connected to the moving shaft 13.

In at least one embodiment, the body 61 of the waterproof ring 60 includes a plurality of annular grooves 613 arranged at intervals, and the annular grooves 613 are arranged concentrically. In this way, the waterproof ring 60 has a larger surface area. In at least one embodiment, the waterproof ring 60 is elastic. In detail, the waterproof ring 60 is made of soft material, such as rubber or flexible plastic.

When the driving device 1 works, the moving shaft 13 linearly reciprocates, the moving shaft 13 drives the waterproof ring 60 to linearly reciprocate simultaneously. As the waterproof ring 60 has elasticity and has a large surface area due to the annular grooves 613, when deformed the waterproof ring 60 may not be damaged, or interfere with the operation of the driving device 1, and the waterproof ring 60 always maintain a sealed connection with the moving shaft 13.

Specifically, the waterproof ring 60 will not interfere with the operation of the moving shaft 13.

In at least one embodiment, the massaging device 200 further includes an inner housing 21, and the inner housing 21 is arranged in the lower housing 20. A flange 63 is disposed on a side of the waterproof ring 60 away from the first air outlet 33, and the flange 63 is disposed on the inner housing 21.

The above are only alternative embodiments of the present disclosure, and thus do not limit the scope of the present disclosure. Under the inventive concept of the present disclosure, equivalent structural transformations made by the description and drawings of the present disclosure, or direct/indirect application in other related technical fields are included in the scope of the present disclosure.

What is claimed is:

1. A sucking and air blowing structure, applied to a massaging device, wherein the sucking and air blowing structure comprises:
a driving device, provided with a piston, the piston is capable of linearly reciprocating under an action of the driving device; and
a venting device, connected with the driving device, the venting device defines a cavity cooperated with the piston, the piston is capable of linearly reciprocating in the cavity, the venting device further defines a first air outlet communicated with the cavity;
when the piston linearly reciprocates in the cavity, internal air pressure and external air pressure of the cavity are balanced through the first air outlet, to form a sucking and air blowing effect.

2. The sucking and air blowing structure of claim 1, further comprising:
a boosting device, arranged at the first air outlet and sealingly connected with a side wall of the first air outlet, the boosting device defines a second air outlet, a diameter of the second air outlet is larger than a diameter of the first air outlet.

3. The sucking and air blowing structure of claim 2, wherein the boosting device is a straight air outlet pipe integrally formed with the side wall of the first air outlet.

4. The sucking and air blowing structure of claim 3, wherein the straight air outlet pipe includes a flexible air outlet pipe, the flexible air outlet pipe is bendable, a free end of the flexible air outlet pipe is connected with a first air outlet head, the first air outlet head is matched with a sensitive portion of a user in shape, and configured to inhale air and blow out air.

5. The sucking and air blowing structure of claim 2, wherein the boosting device is a second air outlet head sealingly connected with the side wall of the first air outlet, and the second air outlet head is matched with a sensitive portion of a user in shape, and configured to inhale air and blow out air.

6. The sucking and air blowing structure of claim 1, further comprising a sealing ring arranged on a side wall of the piston, and the sealing ring is sealingly connected with an inner side wall of the cavity.

7. The sucking and air blowing structure of claim 1, wherein the driving device is a linear motor or a voice coil motor.

8. The sucking and air blowing structure of claim 1, wherein the driving device comprises:
a driving motor;
a first connecting rod, an end of the first connecting rod is connected with an output shaft of the driving motor;
a second connecting rod, an end of the second connecting rod is connected with an end of the first connecting rod away from the output shaft of the driving motor; and
a moving shaft, an end of the moving shaft is connected with the piston, and other end of the moving shaft is connected with an end of the second connecting rod away from the first connecting rod;
when the output shaft of the driving motor rotates, the output shaft is configured to drive the first connecting rod to rotate, and drive the moving shaft to reciprocate linearly through the second connecting rod.

9. The sucking and air blowing structure of claim 1, wherein the driving device comprises:
a double shaft driving motor;
a third connecting rod;
a fourth connecting rod, the third connecting rod and the fourth connecting rod are respectively connected with both ends of the double shaft driving motor;
a fifth connecting rod, two ends of the fifth connecting rod are respectively connected with the third connecting rod and the fourth connecting rod; and
a moving shaft, one end of the moving shaft is connected with the piston, and other end of the moving shaft is connected with the fifth connecting rod;
when an output shaft of the double shaft driving motor rotates, the output shaft is configured to drive the third connecting rod and the fourth connecting rod to rotate, and drive the moving shaft to reciprocate linearly through the fifth connecting rod.

10. A massaging device, comprising an upper housing, a lower housing detachably connected with the upper housing, and a sucking and air blowing structure, the upper housing and the lower housing cooperatively form a receiving space for receiving the sucking and air blowing structure, wherein the sucking and air blowing structure comprises:
a driving device, provided with a piston, the piston is capable of linearly reciprocating under an action of the driving device; and
a venting device, connected with the driving device, the venting device defines a cavity cooperated with the piston, the piston is capable of linearly reciprocating in the cavity, the venting device further defines a first air outlet communicated with the cavity;
when the piston linearly reciprocates in the cavity, internal air pressure and external air pressure of the cavity are balanced through the first air outlet, to form a sucking and air blowing effect.

11. The massaging device of claim 10, further comprising a battery and a printed circuit board both received in the receiving space, the printed circuit board is electrically connected with the battery, and the battery is configured to provide a power to the driving device.

12. The massaging device of claim 10, further comprising a waterproof ring, the waterproof ring comprises a body, the body defines a via hole, the driving device comprises a moving shaft, the moving shaft is configured to pass through the via hole and connect with the piston.

13. The massaging device of claim 12, wherein a diameter of the via hole is smaller than a diameter of the moving shaft, so that a side wall of the via hole is sealingly connected to the moving shaft; or
the body of the waterproof ring comprises a plurality of annular grooves arranged at intervals, and the annular grooves are arranged concentrically; or
the waterproof ring is elastic.

14. The massaging device of claim 10, wherein the sucking and air blowing structure comprises:
a boosting device, arranged at the first air outlet and sealingly connected with the first air outlet, the boosting device defines a second air outlet, a diameter of the second air outlet is larger than a diameter of the first air outlet.

15. The massaging device of claim 10, wherein the sucking and air blowing structure comprises a sealing ring arranged on a side wall of the piston, and the sealing ring is sealingly connected with an inner side wall of the cavity; or
the driving device is a linear motor or a voice coil motor.
